(19) United States
(12) Patent Application Publication
(10) Pub. No.: US 2012/0290403 A1
(43) Pub. Date: Nov. 15, 2012

(54) NETWORK-ADVERTISING, OPTIONS PROGRAM (ADVESTOR)

(76) Inventors: Daniel GALITZKY, Haifa (IL); Amir Bahalul, Moshavat Kinneret (IL)

(21) Appl. No.: 13/462,854

(22) Filed: May 3, 2012

Related U.S. Application Data
(60) Provisional application No. 61/483,756, filed on May 9, 2011.

(51) Int. Cl. G06Q 30/02; G06Q 30/06

(52) U.S. Cl. 705/14.69; 705/27.1

(57) ABSTRACT

A system, method and business method implemented by way of a network enabled computer system configured to provide a platform for the trading of online advertising option contracts. The options are for future on-line advertisement rights, where the right to buy the advertisement rights for a predefined price is the traded commodity. The present invention further discloses a Web Site Index Trading Platform for trading based on web site indexes.

This application claims priority from U.S. Provisional Patent Application No. 61/483,756, filed May 9, 2011

### FIELD AND BACKGROUND OF THE INVENTION

The present invention relates to online advertising and, more particularly, to a system for facilitating trading online advertising as a commodity having futures and options.

In a matter of very few years, the Internet has consolidated itself as a very powerful platform that has changed the way we do business and communicate. The Internet, as no other communication medium, has given an International or a “Globalized” dimension to the world and has become a Universal source of information for millions of people, at home, school, and work. These global tendencies together additional Internet users significantly increases the amount of online advertising. According to the web experts in online marketing, the Online Marketing Industry in Display Ad sector will grows from current USD 5.448 billion to USD 7.958 billion in the next 3 year (Source: eMarketer, November 2008, www.eMarketer.com).

Online trading and in particular Foreign Exchange (ForEx or simply forex) trading on the Internet is a highly developed field. Various companies and service providers have emerged as leaders in various disciplines within the field. Some entities are so well known and widely used or referenced that they are considered the standard in whichever niche of the field they dominate. For example, Panda Trading Systems Ltd. supply infrastructure for control and analysis over forex transactions (www.pandats.com). Openforex.com offer algorithms for forex investment strategies and analysis (www.openforex.com). Super Derivatives Inc. is considered the market standard for commodities markets analysis (www.SuperDerivatives.com). Finally, MetaQuotes Software corp. provides a trading arena infrastructure. Several versions of their software product MetaTrader are available with MetaTrader 4 being the most well known and used forex trading platform.

Various attempts have been made to provide a method and tool for trading advertising rights. U.S. Pat. App. No. 2009/0319372 discloses a system for trading existing online advertisement rights and is incorporated by reference for all purposes as if fully set forth herein. The disclosure does not offer a solution for trading in optional advertisement rights, only in current bids and asks.

U.S. Pat. App. No. 2005/0044027 to Rodgers et al. discloses a system and method of trading option contracts, such as foreign currency option contracts. In one embodiment, a system and method for web-based or network-based interactive trading of currency options is described. The disclosure is incorporated by reference for all purposes as if fully set forth herein. Rodgers does not disclose a system or method for trading advertisement option contracts, only contracts such as foreign currency option contracts etc.

U.S. Pat. App. No. 2007/0073605 to Kohavi et al. discloses a method for trading non-financial options in a virtual marketplace. Kohavi is incorporated by reference for all purposes as if fully set forth herein. The method and marketplace of Kohavi is not adapted to be used for Internet advertising. Furthermore, the disclosure does not offer a solution for trading in optional advertisement rights that do not necessarily exist at the time of the purchase.

It would be highly advantageous to have a method, platform, product and system for creating, managing and trading future on-line advertisement rights, where the right to buy the advertisement rights for a predefined price is the traded commodity.

### DEFINITIONS

Following is a glossary of terms used in Advertisement Industry to be used throughout this document:

Advertisers—The party being promoted through an ad campaign.

Agency—A party that manages advertiser campaigns.

Ad Networks—A party having access to multiple publishers.

Publisher—The party displaying the advertising content on an internet based media under his control; an internet based media includes websites, applications for mobile devices, games or other on-line infrastructure configurable to display advertising content.

Online advertising—is a form of promotion that uses the Internet and World Wide Web for the expressed purpose of delivering marketing messages to attract customers. Examples of online advertising include contextual ads on search engine results pages, banner ads, Rich Media Ads, Social network advertising, interstitial ads, online classified advertising, advertising networks and e-mail marketing. An Agency serves as a bridge between an end user (ad consumer) and an Advertiser (e.g. Coca-Cola, Ford etc). Typically, an advertiser turns to an agent to promote an advertising campaign. An advertising campaign is usually multi-faceted, including various types of ad media from billboards, to TV/radio ads, newspapers ads, Internet advertising etc. The agent turns to an Ad Network that specializes in Internet advertising and has access to many publishers. Alternatively, the agent can turn directly to chosen publishers. The Publisher displays the advertising content on the World Wide Web.

Agencies trying to maximize profits are torn between advertising on popular, more expensive sites or on less popular, cheaper sites. Although the situation seems to lack a solution, in the world of commodities and currencies, a solution exists in ‘Options Trading’.

Options are a type of financial instrument classed as derivatives, as they ‘derive’ their value from an underlying asset. An option gives its holder the right, but not the obligation, to buy (Call Option) or to sell (Put Option) some underlying assets on or before the options expiration date at an agreed on price (the strike price).

### SUMMARY OF THE INVENTION

According to the present invention there is provided a method for trading advertising space as a commodity, the method comprising: (a) registering users on a Web Site Trading Platform (Advestor); (b) offering an Advertising Option Contract (Ad-Option) Package for the advertising space, by a first registered user to at least one other registered user, at a strike price; and (c) Trading the Ad-Option Package (OP) on Advestor.

According to further features in preferred embodiments of the invention described below the advertising space is non-existent at the time of the offering.

According to still further features in the described preferred embodiments the OP includes at least one Ad-Option and wherein the OP is created on an Ad-Option Building Platform (ABP).

According to still further features, the Ad-Option is a standardized Ad-Option, wherein the standardized Ad-Option is created on a standardized Ad-Option Template of the ABP.

According to still further features, the offering includes posting the OP to a Purchasing Arena.

According to still further features, the trading includes selling the OP to at least one other registered user.

According to still further features, the step of: (d) the at least one other registered user, to whom OP was sold, realizing the sold OP.

According to still further features, the offering includes posting said OP to an Exchange Arena.

According to still further features, the trading includes at least one activity selected from the group including: Bidding, Asking, selling, exchanging and buying.

According to still further features, the offering includes offering the OP directly to at least one other registered user.

According to still further features, the method further includes the step of realizing the traded OP.

According to still further features, the realized OP has a priority whereby the priority determines a relative viewing priority of the advertising space on an advertising media.

According to still further features, the OP further includes a priority for the at least one Ad-Option whereby a higher priority gives precedence over a lower priority.

According to the present invention there is provided a computing system for facilitating trading of options for purchasing advertising space, the computing system including: (a) a user enrollment interface for registering users of the system; (b) at least one Options Package (OP) belonging to at least one registered user; and (c) a Web Site Trading Platform (Advestor) for effecting trading of the at least one OP by the registered users.

According to still further features, the OP includes at least one advertising options contract (Ad-Option).

According to still further features, the Advestor includes a Purchasing Arena for effecting sales and purchases of at least one OP.

According to still further features, the Advestor includes an Exchange Arena for trading at least one OP.

According to still further features, the Ad-Option includes: (i) a right to purchase said advertising space at a given time; (ii) a strike price for purchasing the right; and (iii) a realization price for purchasing the advertising space at said given time.

According to still further features, the OP further includes a purchase plan based on at least one Ad-Option.

According to still further features, the OP further includes a purchase plan based on at least a given number of Ad-Options.

According to another embodiment, there is provided a method for trading web site indexes, the method including: (a) receiving a first web site index related to a first website; (b) receiving a second web site index relating to a second web site; (c) calculating an exchange rate based on said first and second web site indexes; and (d) trading said indexes based on said exchange rate.

According to still further features, the indexes include at least one index selected from the group including: (i) a Real-Time index; (ii) a short term index; and (iii) a long term index.

According to still further features, the indexes include at least one index selected from the group including: liquid and non-liquid indexes.

According to another embodiment, there is provided an online platform for trading web site indexes, the platform including: (a) a computing system including: (i) a data server adapted to receive and process web site index information; and (ii) a trading engine adapted to calculate index exchange rates by comparing at least two web site indexes; and (b) an interface, configured to facilitate user trading interaction with the computing system over a data network.

According to still further features, the indexes include at least one index selected from the group including: (i) a Real-Time index; (ii) a short term index; and (iii) a long term index.

According to still further features, the indexes include at least one index selected from the group including: liquid and non-liquid indexes.

According to still further features, the data server adapted to receive and process web site index information from at least one source selected from the group including: a web site to which web site index information pertains, and a third party index service.

The present invention discloses an innovative method and system for the purchasing of on-line advertisement ‘purchasing rights’ and not only the on-line advertisement rights from the publisher (the current or future owner of the media). In other words, a “day trader” or any buyer, does not buy the advertisement right from the publisher, but rather the future price of a potential online ad-space. Furthermore, the online media does not necessarily exist at the time of purchase. A portion of the media may already exist, since it can be an expansion of an existing media (web site, mobile devices etc.) or the media may be completely new (new web-site, mobile device applications, new game etc.). The innovative method and system allow for trading and exchanging on-line advertisement purchasing rights (essentially creating an ad-options stock exchange).

### BRIEF DESCRIPTION OF THE DRAWINGS

Various embodiments are herein described, by way of example only, with reference to the accompanying drawings, wherein:

FIG. 1 is a block diagram of an exemplary embodiment of the innovative system of the immediate invention;

FIG. 2 is an exemplary flow diagram of an embodiment of the SiteEx system;

FIG. 3 is a block representation of an exemplary embodiment of the system interface;

FIG. 4 is a flow chart for implementation of the Advestor trading platform;

FIG. 5 is an exemplary computing system.

### DESCRIPTION OF THE PREFERRED EMBODIMENTS

The principles and operation of an on-line advertising method and product based on option trading according to the present invention may be better understood with reference to the drawings and the accompanying description.

The present invention discloses a system, method and business method implemented by way of a network enabled computer system configured to provide a platform for the trading of online advertising options. Although the following disclosure refers primarily to advertising space on online media, it should be understood that the underlying asset of the Ad-Option detailed below may be air-time on a radio broadcast or similar broadcast occurring over the Internet such as a podcast, web-cast etc. as is well known in the art. Furthermore, the underlying asset of the Ad-Option may be air-time on a television broadcast, web-seminar, web-cast, online broadcast and the like as is well known in the art. The aforementioned air-time may be during ‘live’ broadcasts or alternatively may be embedded in recorded material as is also well known in the art.

Advestor—Options Trading System based on Online Advertising

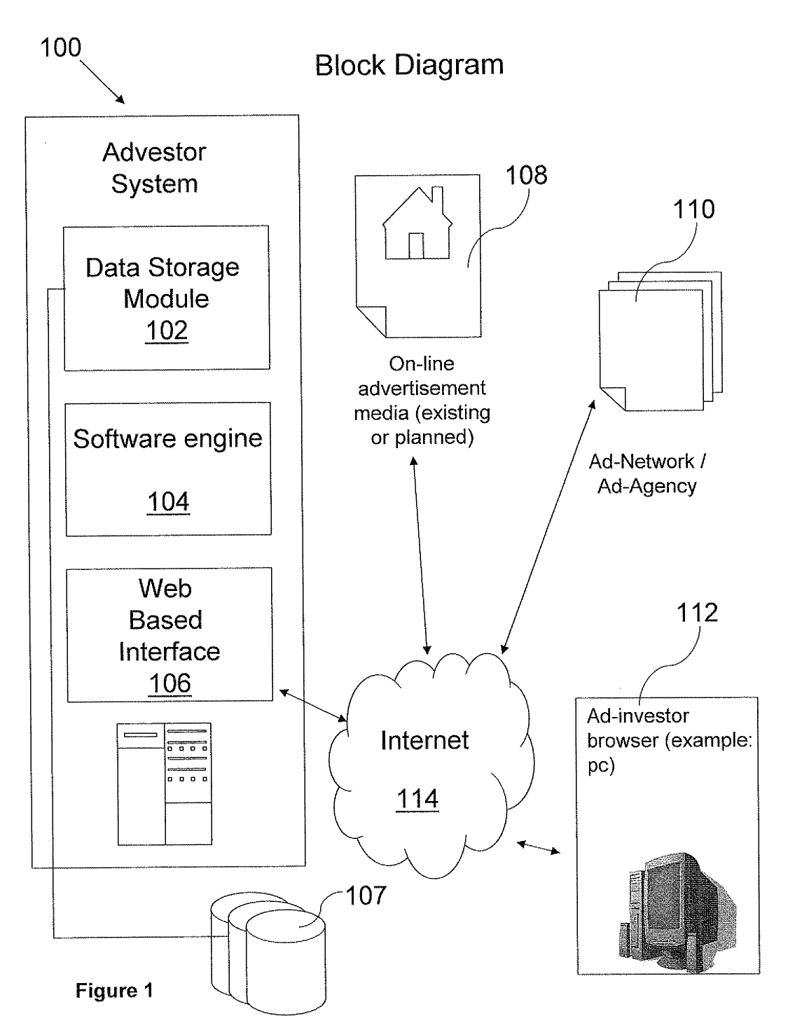

An exemplary embodiment of the immediate innovation is shown in FIGS. 1, 3 and 4. Referring now to FIG. 1, the Figure depicts a block diagram of an exemplary embodiment of the innovative system of the immediate invention. The Advestor system preferably provides a framework and platform for facilitating the organized trading of rights for future purchase of advertising space online (e.g. on websites, online games, etc.) at a predetermined rate (‘options’).

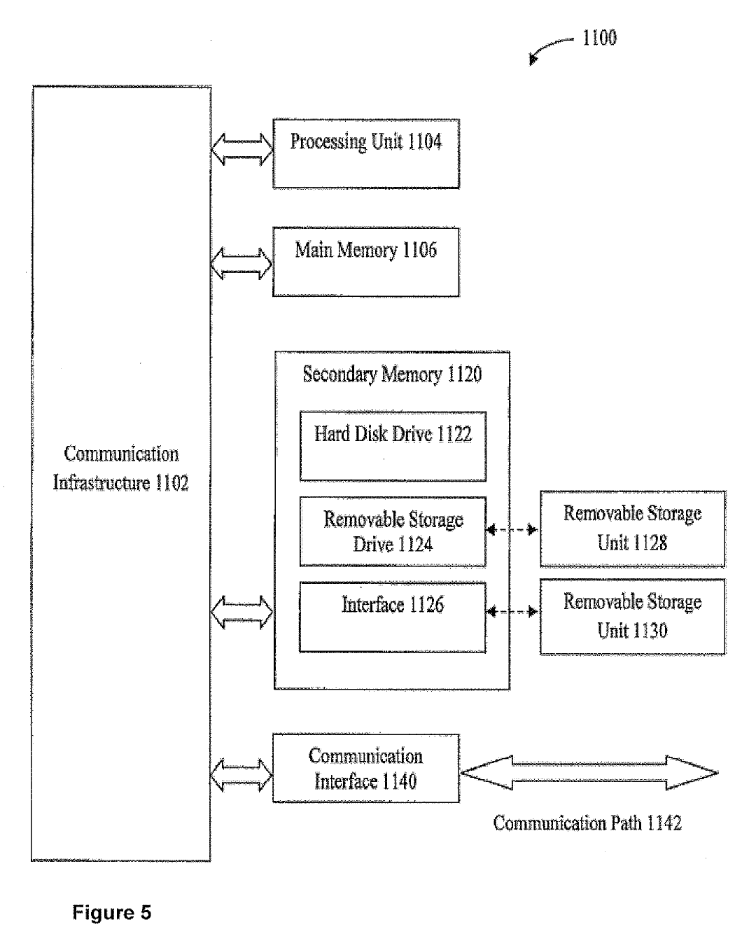

In the currently depicted embodiment, the Advestor Computing System 100 includes various software applications, components and systems. Among the systems and applications are a Data Storage Module 102, a software engine 104 and a Web-based Interface 106. Addition components commonly found on computing systems are depicted in exemplary computer system 1100 in FIG. 5. Advestor Computing System 100 may be implemented on a single or several computing systems such as or similar to computer system 1100 described below. Likewise, system 300, Advestor and SiteEx platforms may be implemented on a single or several computing systems such as or similar to computer system 1100. Data Storage Module 102 (e.g. such as secondary memory 1120) may be stored on a single storage medium or multiple storage mediums either collocated or distributed over a plurality of interconnected storage mediums. A storage medium, or plurality of storage mediums 107 may be housed in the server or plurality of servers or externally thereto (as depicted in the Figure).

Data Storage Module 102 includes relevant information regarding Publishers, Advestors, Agencies, Ad Networks, Investors and of course the options information and all the data relating to the options. Software engine 104 provides the instruction sets for facilitating the functions necessary for selling, purchasing and otherwise trading Ad-options and/or other advertisement rights between users of the system of the current invention. In some embodiments, the system may further supply a framework within the platform for the realization of purchased or traded advertisement rights. In some embodiments the system provides an optional method for advertisers, agencies, ad-networks and investors to search/browse through advertisement rights purchased by other system users and offer the owners bids for purchasing the rights. Furthermore, financials tools and data gathering and analyzing engines may also be included in the system. The tools and engines may be implemented as an integral part of the system or be provided by an external service accessing the system.

Web based interface 106 allows Advestors, Publishers, ad networks, agencies, investors and any other interested parties to access the platform via a data network such as the Internet or other platform (by phone, email etc) 114. Users can either download client software to be installed on a local computing device (e.g. download a desktop application or download a mobile application for a mobile device) or alternatively the user can access the interface 106 using a web-browser or other access tool 112 and make use of the various services and features available thereon. The web resource may have a standardized GUI for any participant to register and logon to the system. In some embodiments, specialized APIs can be implemented to interface directly between a user system (e.g. such as the computer network of an ad network) and the innovative system 100. For example, Ad networks may have a specialized API that automatically updates prices and other parameters for packages that are part of their portfolio or that they are bidding on.

In an exemplary, non-limiting embodiment, a Publisher sells rights (options) to future advertising rights on a specified site 108, at a future date for a predefine period of time, at a predefined price (e.g. a price assessed to be lower than the price will be at the predefined time in the future) in exchange for (immediate) payment. When the future date arrives the option holder can realize the option (i.e. buy the advertising space at the predetermined price), or to sell the option to an agency, ad network or investor at a preferably higher price than he paid for the option, but where the option price is still lower than the going price (real-price) even with the fee for the option (strike price). This arrangement is advantageous for all interested parties:
Publisher 108 has removed the uncertainty of advertising prices resulting from unpredictable site traffic and has generated an immediate income from the sale of options. Furthermore, the Publisher can generate revenues during critical, startup stages of the site (or game or application or other Internet based media etc.), or for the creation of new projects etc., through the sale of future advertising options. This is a better idea than giving part of the company to investors in the form of stocks and shares or board positions.
Ad Network 110 can secure future advertising space and no longer has to be concerned about a shortage of advertising space for the advertising needs of the client.
Agencies and Ad networks 110 possessing future advertising rights are able to provide clients with premium, high traffic sites while preserving profit margins in accordance with the advertising prices set forth in the advertising futures.
Both Agencies and Ad Networks are able to plan budgets more accurately in view of resulting stabilized advertising costs. Furthermore, the innovative system allows for Agencies/Ad Networks/Investors to purchase future (and current) advertisement rights, from a single or from multiple publishers.
Advertisers benefit from reduced Advertising costs obtained from Agencies possessing future advertising rights on (current or future) media at reduced prices as set forth in the advertising options owned by the Agents. The Agents secure the right to buy advertising space on a specific site at a predetermined time for a predetermined price. Ideally, the Option price for the advertising space is lower than the real offered price for the same advertising space at the future date, so that the Advertiser has benefitted from securing the right to advertise early on. In the best case scenario, the Option price is sufficiently lower than the real-time price, that each entity existing between the Publisher and Advertiser can make a sufficient profit while still providing the advertiser with a beneficial advertising price.
Advertising Options Holders (110, 112) are able to trade options in accordance with prevailing market conditions. As long as the difference between the option realization price and the real-time is great enough for the Holder to make a profit in his original investment when reselling the Option to a new party.
Investors have new investment opportunities for buying options associated with low-rating sites in order to sell the options in the future when the site ratings improve. These Investors are sometimes referred to herein as “Advestors” 112.

Exemplarily, a new website (or one still being built) is selling ad space at $7 for Cost Per Mille (CPM). In the future, if the site becomes popular, the projected price for advertising on the site is $10 CPM. Today, the site can offer the right to advertise on the site for the coming year at the price of $8 CPM for 100 units (totaling $800). The price for this right will be $0.25 per unit (total price of option=$25). When the stipulated time arrives, and the site has in fact become more popular (e.g. the site has reached a predefined number of visitors per day/week/month or that the site's audience is more attractive for Advertisers etc.), someone who purchased the option now holds the right to realize the option, i.e. to purchase the advertising space worth $1000 at the price of $800. The owner can either realize the option by buying the advertising space (e.g. if the owner is an ad agency), or alternatively, the owner could sell the rights to an ad agency/ad network/investors or even back to the publisher himself (via the innovative platform discussed below) and reap the profits. In this example, the price of the option is separate from (and in addition to) the price of the actual ad space. In an alternative configuration of the transaction, the option price can be deducted from the ad space price. Cost Per Action/Acquisition (CPA) is one possible predefined pricing method. The options might alternatively offer predefined prices for Cost Per Click (CPC)/CPA and other advertisement packages etc.

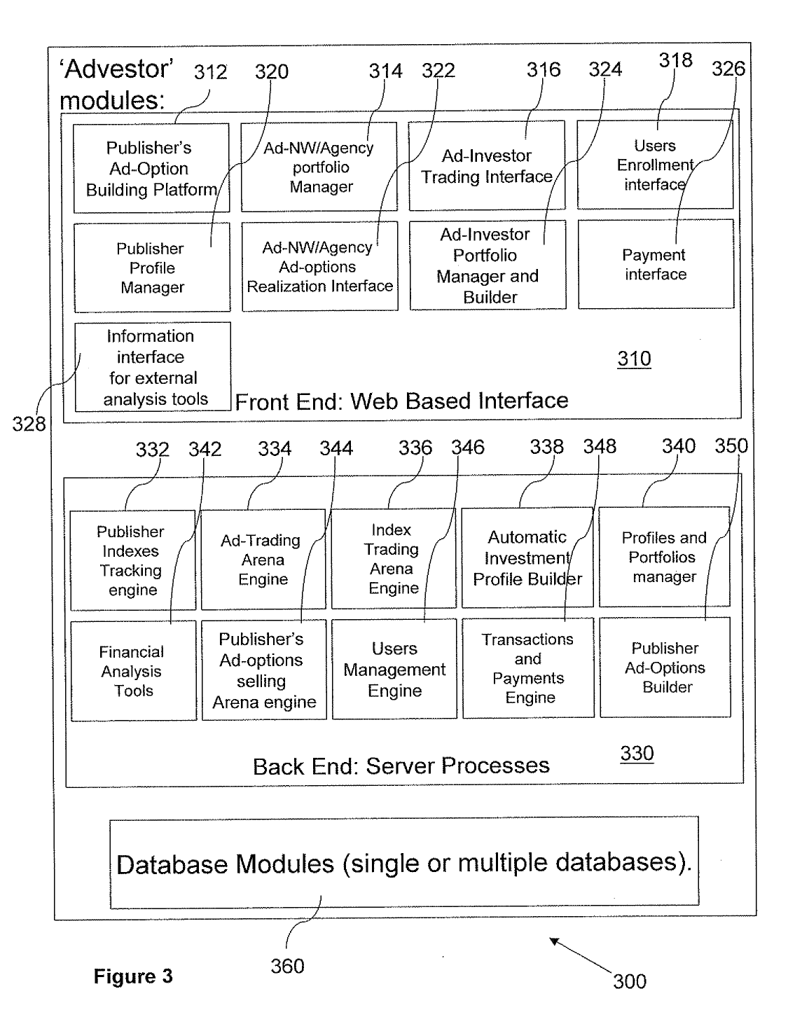

Referring now to FIG. 3, FIG. 3 depicts a block representation of an exemplary embodiment of the system 300. The platform allows users to invest both large and small amounts of money. The platform can provide a cross-section of websites according to various indicators, such as, but not limited to, the level of risk for each site, the subject matter of the site, the age of the site etc. This type of feature is very similar or even parallel to features offered by other financial tools.

Innovative software collects and analyses data regarding indices and advertising prices on the Internet. The software allows the system to set current prices for advertising on a given website as well as forecast future worth and pricing for the site. The data may be received from ‘plugins’ and/or embedded code located at the Publisher site. The data may include up-to-date information on user traffic as well as data regarding attempts to inflate the user traffic data. Furthermore, innovative algorithms drive data-collection engines to gather and analyze geo-political variables which influence the popularity of websites dedicated to certain areas of interest. The platform includes interfaces for collaborating with external entities (e.g. Google Analyties™, alexa.com etc).

An exemplary, non-limiting, representation of tools and features provided to a user of the system are included in the Front End Interface 310 of system 300. Interface 310 is a detailed but merely exemplary implementation of Web Based Interface 106. Exemplarily, the system provides a Publisher Ad-Option Building Platform 312, an Ad-Network/Agency portfolio Manager 314, an Ad-Investor Trading Interface 316, a Users Enrollment interface 318, a Publisher Profile Manager 320, an Ad-Network/Agency Ad-options Realization Interface 322, an Ad-Investor Portfolio Manager and Builder 324, a payment interface 326 and an Information Interface 328 for external analysis tools.

Publishers wishing to sell adverting options on the system must first register on the system. The same holds true for Ad-Networks, Ad-Agencies, and Investors. All of the aforementioned entities can use Users Enrollment interface 318 to register on the system. After enrolling via User Enrollment Interface 318 a user will be able to interface with platform via interface 106 as detailed above for FIG. 1.

Ap-Option Building Platform (ABP) 312 provides tools for creating Option Packages. Publishers who have advertising space on existing or even non-existing media can create advertising options contracts (or simply ‘options’ or ‘Ad-Options’ for further distinction) which include the relevant details of the advertising space, the term of the contract (also known as ‘tenor’), strike price, realization price, priority and other relevant details. Preferably the options are created on an Ad-Options Template (OT) thereby standardizing the format of the options. OPs include at least one options contract and a plan for the purchase of the option. A number of Option Package plans are detailed below in the Examples. Publishers can maintain public or private (or a hybrid of both public and private) Profiles on the system using Publisher's Profile Manager 320.

Ad-Networks and agencies can manage their portfolios on the system using Ad-Network/Agency portfolio Manager 314. An individual investor (or group of individuals banding together as a single investing entity) can build and mange their portfolio using Ad-Investor Portfolio Manager and Builder 324.

For trading on Advestor, investor entities (i.e. Ad-Networks/Agencies and individual investors or Advestors) use Ad-Investor Trading Interface 316 to effect all trading activities. Trading activities can be effected using various financial tools available on the platform. Activities such as buying, selling, providing Bid and Ask positions, exchanges etc. can all be effected using Interface 316. Should an investor or Ad-Network/Agency wish to realize an Ad-option, Ad-Network/Agency Ad-options Realization Interface 322, provides the tool for this activity. Payments can be made on the system using payment interface 326 or other external payment methods as are well known in the art. Finally, Information Interface 328 provides a gateway for external analysis tools.

An exemplary, non-limiting, representation of some system processes provided by the system but not ‘visible’ to the users are included in a Back End Server System 330 of System 300. Server System 330 is a detailed but merely exemplary implementation of Software Engine 104. Exemplarily, the system includes a Publisher Indexes Tracking engine 332, an Ad-Trading Arena Engine 334, an Index Trading Arena Engine 336, an Automatic Investment Profile Builder 338, a Profiles and Portfolios manager 340, a Financial Analysis Tools 342, a Publisher's Ad-options selling Arena engine 344, a Users Management Engine 346, a Transactions and Payments Engine 348, and a Publisher Ad-Options Builder 350. Additionally, the system may include various Data Storage Modules 360. Storage Modules 360 are an exemplary implementation of Data Storage Module 102.

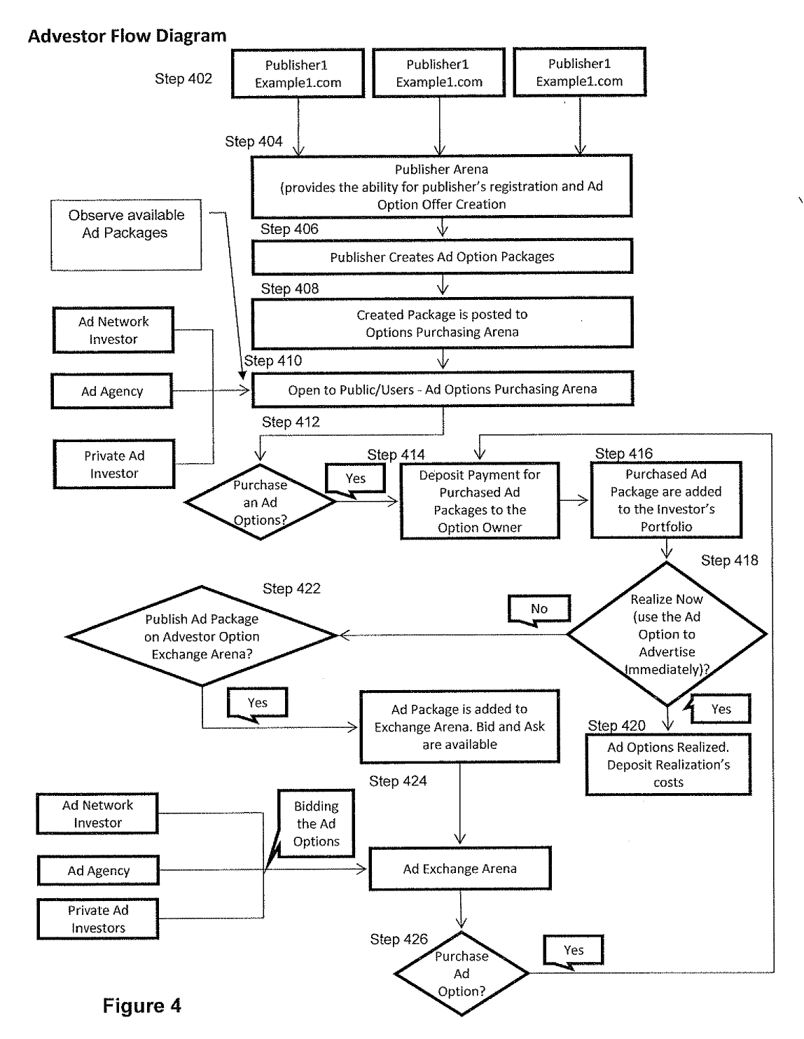

Publisher Ad-Options Builder 350 is the engine which supports Publisher's Ad-Options builder platform 312. Transactions and Payments Engine 348 power and facilitate all payments and transactions made on the system, specifically payments made through payment interface 326. Publisher's Ad-options Selling Arena engine 344 supports the activities on Advestor's Purchasing Arena (see at least step 404 below). Financial Analysis Tools 342 provides the financial analysis for the traded commodities used for the portfolio builder and manager 324 and for the external tools 328. Users Management Engine 346 manages the various users on the system and provides updates regarding status of user accounts, maintenance issues and various notifications to users whether the users are connected to the system or not (e.g. via email or the like). Automatic Investment Profile Builder 338 creates user profiles based on trading activity such as purchases and sales of Ad-Options. Profiles and Portfolios manager 340 provides profile and portfolio support and maintenance including updating profiles and portfolios according to trading activities, purchases and sales. Ad-Trading Arena Engine 334 powers all the features provided by Advestor trading arena depicted in FIG. 4. Data Storage Modules 360 store all the relevant data from the various modules on the platform as well as trading information. Some of the systems support the Index Trading System (SiteEx) which is discussed below and are described in detail there. The aforementioned systems may be implemented as separate systems or in other configurations as would be clear to one skilled in the art.

FIG. 4 is an exemplary, non limiting flow chart for implementation of the Advestor trading platform. The innovative platform serves as a trading house/platform/arena for advertising futures and options, thus changing advertising rights into a financial commodity and the platform into a financial tool. In some embodiments there can be separate areas for trading directly from publishers (Purchasing Arena) and for re-trading (Exchange Arena). In other embodiments, both types of commodities can be traded in the same area.

Advestor flow diagram 400 includes the following exemplary steps that can be taken in some embodiments of the invention:

Step 402 Publishers having existing advertising space or Publishers that plan to have advertising space decide to offer options packages on the Advestor platform.

Step 404 Publishers register on the system using the Publisher Interface which provides the ability for publishers to both register and offer an ad option contracts, building the offer using the Publisher Ad-Option Building Platform 312.

Step 406 Publisher creates Ad Option packages (including at least an advertising option contract which may be bundled together with other contracts or elements such as those described below in the examples) using building platform 312.

Step 408 The created package is initially posted to an Options Purchasing Arena.

The above process may either be done manually or automatically. Preferably building platform 312 provides standardized option contract templates for creating standardized option contracts (or simply ‘options’). Building platform 312 provides addition financial tools for creating an options package which includes at least one advertising option.

Step 410 Posted Ad Option becomes available for observation and/or purchase. Ad Networks/Agencies and Advestors can view the offerings posted on Arena 214. Various tools, features and interfaces may be offered for observing and analyzing on the Purchasing Arena.

Step 412 Investors (individuals, networks, agencies etc.) have the opportunity to purchase an Ad Option.

Step 414 A party interested in purchasing an Option pays the option owner for purchased Ad Package(s). In some embodiments, the payment can be from a prepaid account on the platform to the owner's account on the platform. Alternatively, payment is effected via standard sources such as a bank transfer etc.

Step 416 The purchased Options are added to the Investor's portfolio.

Purchase process ends here. In some embodiments of the invention, the publisher may decide to post the Option Package (OP) directly to the Exchange Arena, i.e. in place of step 410, go straight to step 424. In still other embodiments, a publisher (or investor) may offer an OP directly to one or more registered users (e.g. via a message account on the Advestor platform or via email, text message, telephonic message or any other type of person-to-person or person-to-group communication method).

Step 418 The Investor has the opportunity to realize the Ad option now (according to the terms of the option).

Step 420 The Ad Option is realized and the Realization payment is made to the owner, either directly from the option holder or through the Advestor infrastructure.

Step 422 If not realized, an Ad Option can be published to on the Option Exchange Arena.

Step 424 The Ad Option or Package is added to the Exchange Arena. Bid and Ask positions can commence. Ad Network/Agency investors as well as private investors can bid on published Ad Options.

Step 426 When a Bid wins, then the investor has the choice of purchasing the Ad Option. If the Option is purchased then go to Step 414.

Priority

If the commodity is the right to buy the ad space, then it follows that the ad space option may come with a priority at which the commodity is bought. For example, an up and coming web resource may sell options for three months time at the current or slightly elevated price (but presumed to be below the future price to which the option refers). But due to the expected demand for the same space, the option may be for a 1^{st} priority space (i.e. the ad appears first when a surfer accesses the page) or a 2^{nd} priority or a 3^{rd}. The further down the ladder the priority is the cheaper the option is. Preferably the priority of an option is included in the Option Package plan.

Other attributes (such as the priority mentioned above), may also be offered and affect the option's term and price.

### Example 1

### Option Package Plans Offered by a Publisher for a Specific advertising space

In the first plan the offer is to buy the right to buy advertising space for at CPM of 7$ for 3 months following the purchase date of the option. The plan will be offered until Apr. 4, 2012. The option cost is 1$ and the minimum options amount that can be bought is 1 unit.

The second plan details an offer to buy the right to buy advertising space at a CPM of 7$. The right is must be realized within 3 months of the purchase date. The option cost is 0.5$ and the minimum options amount that can be bought is 1000 (the right to buy 1000 packages of 1000 impressions at a cost of 7$ for each package).

| | | Option | | |
|---|---|---|---|---|
| CPM/CPA/ | Realization | cost | Offer plan | Min |
| CPC | within | ($) | until | Amount |
| CPM 7 $ | 3 Months | 1 | Apr. 1^{st}_{,} 2011 | 1 |
| CPM 7 $ | 3 Months | 0.5 | Inf. | 1000 |

### Example 2

### Option Package Plans Offered by a Publisher for a Specific Advertising Space

In this example, the system provides a method for prioritizing the ad space usage in the case of multiple options realization in a short period of time. In such case, an owner holding options with priority A will have the right to use the ad space purchased prior to owners holding lower priorities options.

| | | | Option | | |
|---|---|---|---|---|---|
| CPM/CPA/ | Realization | Option | cost | Offer plan | Min |
| CPC | within | Priority | ($) | until | Amount |
| CPM 8 $ | 3 Months | A | 1 | Apr. 1^{st}_{,} 2011 | 1 |
| CPM 8 $ | 3 Months | C | 0.5 | Apr. 1^{st}_{,} 2011 | 50 |

### SiteEx—Website-Based Indexes Trading Platform

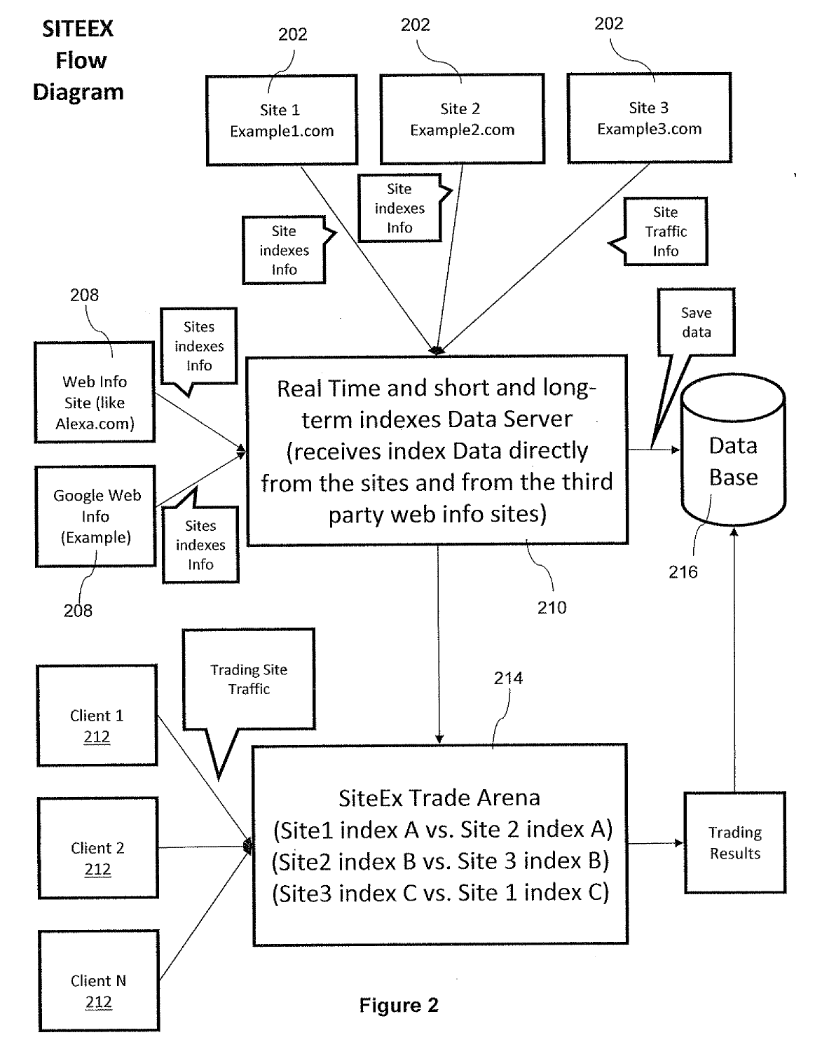

The present invention further discloses a Web Site Index Trading Platform (SiteEx) analogous to the FOREX financial market—but adapted for trading based on web site indexes as opposed to, say, currencies. Primarily, the SiteEx feature of the invention is modeled on the Forex trading platforms but the implementation of the concept is significantly distinct to such a degree that the platforms are incompatible. On the other hand, where applicable, terminology has been borrowed from the field of trading in general and from the Forex field in particular. FIG. 2 is an exemplary flow diagram of an exemplary embodiment of the SiteEx system.

In the SiteEx platform, web site traffic ratio may be treated as the measure of site value in the same manner that currency exchange rate is the measure of value of currencies. Other liquid and non-liquid measurable indexes may also be used to measure value. The present invention includes any site index used as a measure of web traffic to establish site value. For example, if current CNN.com traffic ratio is 25000 concurrent users and Yahoo.com traffic ratio is 35000 concurrent users, the SiteEx trader will be able to open position for the pair CNN/Yahoo that current value is 0.71428 (25000/35000). All forms of transactions employed in FOREX are applied to the trading arena of online web advertising. In a non-limiting example, if a trader buys the “long” (in FOREX this represents buying the ‘first currency’ and paying with the ‘second currency’) and if at sometime the first ‘currency’ appreciates in value, the trader will achieve the revenue according to the lot amount.

In a preferred embodiment of the invention, the SiteEx platform provides real-time site-traffic data 210 and allows a trader 212, as with FOREX, to open, close and updated positions. Data Server 210 receives index information directly from the websites of interest and/or from third party services. Short term and long term indexes are also stored on Data Server 210. Real-Time, short and long term indexes Data Server 210 is powered by Index Trading Arena Engine 336 (FIG. 3) which can be considered the ‘heart’ of the SiteEx trading platform. Publisher Indexes Tracking engine 332 (FIG. 3) receives or extracts site index information from various publisher sites for use in tracking the sites for analysis and exchange purposes. Unlike existing currency exchange platforms or interest rates exchange platforms, the SiteEx trades with both liquid and non-liquid indexes that are derived from web-based services such as web-sites 202, on-line games 202, mobile applications 202 and the like. Some non-limiting examples of traffic indices include non-liquid indices such as: Cost Per Mille (CPM), Cost per click (CPC), cost per action/acquisition (CPA), site click through rate (CTR); and liquid indices such as: average staying time in the site, average seconds spent on each page view, current number of users—all of which can be compared between two website or two online services (see Glossary for explanation of terms).

It should be appreciated that the present invention may include site traffic indices provided by external publishers or web traffic monitors as well as other indices generated by present platform. Exemplarily, the indices may be generated from data gathered from, but not limited to: specialized integrated code on the target web resource which provides data directly to the innovative platform; an online service which monitors the web resource in question; third party suppliers 208 (e.g. alexa.com, Google Analytics™); information gathered by the website itself and shared with the platform and the like. The system gathers the information and stores the information in a database such as Database 216.

Referring now to FIG. 5, the figure depicts computer system 1100 which includes a processing unit 1104 that includes one or more processors. Processor unit 1104 is connected to a communication infrastructure 1102, which may comprise, for example, a bus or a network.

Computer system 1100 also includes a main memory 1106, preferably random access memory (RAM), and may also include a secondary memory 1120. Secondary memory 1120 may include, for example, a hard disk drive 1122, a removable storage drive 1124, and/or a memory stick. Removable storage drive 1124 may comprise a floppy disk drive, a magnetic tape drive, an optical disk drive, a flash memory, or the like. Removable storage drive 1124 reads from and/or writes to a removable storage unit 1128 in a well-known manner. Removable storage unit 1128 may comprise a floppy disk, magnetic tape, optical disk, or the like, which is read by and written to by removable storage drive 1124. As will be appreciated by persons skilled in the relevant art(s), removable storage unit 1128 includes a computer usable storage medium having stored therein computer software and/or data.

In alternative implementations, secondary memory 1120 may include other similar means for allowing computer programs or other instructions to be loaded into computer system 1100. Such means may include, for example, a removable storage unit 1130 and an interface 1126. Examples of such means may include a program cartridge and cartridge interface (such as that found in video game devices), a removable memory chip (such as an EPROM, or PROM) and associated socket, and other removable storage units 1130 and interfaces 1126 which allow software and data to be transferred from the removable storage unit 1130 to computer system 1100.

Computer system 1100 may also include a communication interface 1140. Communication interface 1140 allows software and data to be transferred between computer system 1100 and external devices. Examples of communication interface 1140 may include a modern, a network interface (such as an Ethernet card), a communications port, a PCMCIA slot and card, or the like. Software and data transferred via communication interface 1140 are in the form of signals which may be electronic, electromagnetic, optical, or other signals capable of being received by communication interface 1140. These signals are provided to communication interface 1140 via a communication path 1142. Communications path 1142 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1128, removable storage unit 1130 and a hard disk installed in hard disk drive 1122. Computer program medium and computer readable medium can also refer to memories, such as main memory 1106 and secondary memory 1120, which can be semiconductor devices (e.g., DRAMS, etc.). These computer program products are means for providing software to computer system 1100.

Computer programs (also called computer control logic, programming logic, or logic) are stored in main memory 1106 and/or secondary memory 1120. Computer programs may also be received via communication interface 1140. Such computer programs, when executed, enable the computer system 1100 to implement features of the present invention as discussed herein. Accordingly, such computer programs represent controllers of the computer system 1100. Where the invention is implemented using software, the software may be stored in a computer program product and loaded into computer system 1100 using removable storage drive 1124, interface 1126, or communication interface 1140.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

While the invention has been described with respect to a limited number of embodiments, it will be appreciated that many variations, modifications and other applications of the invention may be made. Therefore, the claimed invention as recited in the claims that follow is not limited to the embodiments described herein.

### GLOSSARY

CPM—Cost Per Mille refers to the cost per thousand (mile in Latin is 1000) impressions. An impression is an instance that an advert is viewed by a viewer/user. An advertiser buys ad space on the basis of the number of impressions desired. The total price paid in a CPM deal is calculated by multiplying the CPM rate by the number of CPM units. For example, one million impressions at $10 CPM equals a $10,000 total price.

CPC and CTR—Cost Per Click (CPC). Known also as pay-per-click (PPC) from the publisher's point of view. In this model the advertiser pays for each click made on a banner impression. Payment depends on the number of clicks solely. For example, a banner is being shown 200,000 times, and being clicked 1000 times at a cost of $0.08 per click. The Click Through Rate (CTR) in this case is 1000/200,000=0.5%. The cost to the advertiser would be $0.08*1000=$80. Since the advertiser paid $80 for 200,000 we say that his Effective CPM (or eCPM) is 80/200=$0.4.

CPA—Cost Per Acquisition/Cost Per Lead/Cost Per Sale. In this model the advertiser pays explicitly per transaction type made by the buyer that resulted from a click on a banner impression. Payment depends either on the cost of lead, cost of sale or a percentage of the sale's revenue. For example, a banner is being shown 200,000 times, and being clicked 1000 times. 10 clicks converted to a lead where the advertiser pays 5$ per lead. The total advertising cost would be 10*5=50$.

Strike price—The price at which the sale takes place.

Realization price—the price at which the asset (advertising space) may be purchased. In some embodiments the strike price is included in the realization price while in other embodiments the strike price is separate to the realization price.

Maturity date—the future date stipulated in the option.

Exercising a right—If the owner of the contract exercises this right, the counter-party has the obligation to carry out the transaction.

Call option—the buyer of a Call option although has a right to buy a certain quantity of the underlying asset, at a specified price on or before a given date in the future, he however has no obligation whatsoever to carry out this right.

Put option—similarly, the buyer of a Put option although has the right to sell a certain quantity of an underlying asset, at a specified price on or before a given date in the future, he however has no obligation whatsoever to carry out this right.

What is claimed is:

1. A method for trading advertising space as a commodity, the method comprising:
(a) registering users on a Web Site Trading Platform (Advestor);
(b) offering an Advertising Option Contract (Ad-Option) Package for the advertising space, by a first said registered user to at least one other said registered user, at a strike price; and
(c) Trading said Ad-Option Package (OP) on said Advestor.

2. The method of claim 1, wherein said advertising space is non-existent at the time of said offering.

3. The method of claim 1, wherein said OP includes at least one said Ad-Option and wherein said OP is created on an Ad-Option Building Platform (ABP).

4. The method of claim 3, wherein said Ad-Option is a standardized Ad-Option, wherein said standardized Ad-Option is created on a standardized Ad-Option Template of said ABP.

5. The method of claim 1, wherein said offering includes posting said OP to a Purchasing Arena.

6. The method of claim 5, wherein said trading includes selling said OP to at least one other said registered user.

7. The method of claim 6, further comprising the step of:
(d) realizing said sold OP by said at least one said other registered user to whom said OP was sold.

8. The method of claim 1, wherein said offering includes posting said OP to an Exchange Arena.

9. The method of claim 8, wherein said trading includes at least one activity selected from the group including: Bidding, Asking, selling, exchanging and buying.

10. The method of claim 1, wherein said offering includes offering said OP directly to at least one other said registered user.

11. The method of claim 1, further comprising the step of realizing said traded OP.

12. The method of claim 11, wherein said realized OP has a priority whereby said priority determines a relative viewing priority of the advertising space on an advertising media.

13. The method of claim 3, wherein said OP further includes a priority for said at least one Ad-Option whereby a higher said priority gives precedence over a lower said priority.

14. A computing system for facilitating trading of options for purchasing advertising space, the computing system comprising:
(a) a user enrollment interface for registering users of the system;
(b) at least one Options Package (OP) belonging to at least one said registered user; and
(c) a Web Site Trading Platform (Advestor) for effecting trading of said at least one OP by said registered users.

15. The system of claim 14, wherein said OP includes at least one advertising options contract (Ad-Option).

16. The system of claim 15, wherein said Advestor includes a Purchasing Arena for effecting sales and purchases of said at least one OP.

17. The system of claim 15, wherein said Advestor includes an Exchange Arena for trading said at least one OP.

18. The system of claim 15, wherein said Ad-Option includes:
(i) a right to purchase the advertising space at a given time;
(ii) a strike price for purchasing said right; and
(iii) a realization price for purchasing the advertising space at said given time.

19. The system of claim 15, wherein said OP further includes a purchase plan based on said at least one Ad-Option.

20. The system of claim 15, wherein said OP further includes a purchase plan based on at least a given number of said Ad-Options.

21. A method for trading web site indexes, the method comprising:
(a) receiving a first web site index related to a first website;
(b) receiving a second web site index relating to a second web site;
(c) calculating an exchange rate based on said first and second web site indexes; and
(d) trading said indexes based on said exchange rate.

22. The method of claim 21, wherein said indexes include at least one index selected from the group including:
(i) a Real-Time index;
(ii) a short term index; and
(iii) a long term index.

23. The method of claim 21, wherein said indexes include at least one index selected from the group including: liquid and non-liquid indexes.

24. An online platform for trading web site indexes, the platform comprising:
(a) a computing system including:
(i) a data server adapted to receive and process web site index information; and
(ii) a trading engine adapted to calculate index exchange rates by comparing at least two said web site indexes; and
(b) an interface, said interface configured to facilitate user trading interaction with said computing system over a data network.

25. The platform of claim 24, wherein said indexes include at least one index selected from the group including:
(i) a Real-Time index;
(ii) a short term index; and
(iii) a long term index.

26. The platform of claim 24, wherein said indexes include at least one index selected from the group including: liquid and non-liquid indexes.

27. The platform of claim 24, wherein said data server adapted to receive and process said web site index information from at least one source selected from the group including: a web site to which said web site index information pertains, and a third party index service.
